(19) United States
(12) Patent Application Publication
(10) Pub. No.: US 2020/0119926 A1
(43) Pub. Date: Apr. 16, 2020

(54) METHODS AND SYSTEMS FOR PROCESSING HIGH VOLUME, FAST SETTLEMENT BLOCKCHAIN TRANSACTIONS

(71) Applicant: Pablo Javier BUKI, San Rafael, CA (US)

(72) Inventor: Pablo Javier BUKI, San Rafael, CA (US)

(21) Appl. No.: 16/624,272

(22) PCT Filed: Jul. 6, 2018
(86) PCT No.: PCT/US2018/041153

§ 371 Date: Dec. 18, 2019

Related U.S. Application Data
(60) Provisional application No. 62/529,528, filed on Jul. 7, 2017.

(51) Int. Cl. H04L 9/32; G06Q 20/38; G06Q 20/06; G06Q 20/40; H04L 9/06

(52) U.S. Cl. CPC H04L 9/3239; G06Q 20/389; G06Q 20/065; G06Q 2220/00; H04L 9/0637; H04L 2209/38; H04L 2209/56; G06Q 20/401

(57) ABSTRACT

Some embodiments include a blockchain method performed by a validator node of a first federation, the validator node including a transceiver and a processor, the method including: receiving, via the transceiver, incoming interfederation blocks (“IFBs”) from a second federation different than the first federation; validating the incoming IFBs to create validated IFBs; splicing the validated IFBs into validated transactions between payer-federation and receiver-federation pairs; merging the validated transactions based on the respective destinations of each validated transaction to create outgoing IFBs; proposing, to other validator nodes in the first federation, that an IFB of the outgoing IFBs be routed to a third federation different than the first federation and the second federation; and proposing, to other validator nodes in the first federation, that a transaction associated with the IFB of the outgoing IFBs be written to a blockchain.

### CROSS-REFERENCE TO RELATED APPLICATIONS

This application claims the benefit of U.S. Provisional Application No. 62/529,528, filed Jul. 7, 2017, the entire contents of which are incorporated herein by reference.

### FIELD

This disclosure generally relates to blockchain technology. More particularly, this disclosure relates to methods and systems for processing high volume, fast settlement blockchain transactions.

### BACKGROUND

Blockchain technology (sometimes referred to simply as blockchain) is a relatively new technology that has been used in digital currency implementations. It is described in a 2008 article by Satoshi Nakamoto, called “Bitcoin: A Peer-to-Peer Electronic Cash System,” the entire contents of which are incorporated herein by reference. The blockchain is a data structure that stores a list of transactions and can be thought of as a distributed electronic ledger that records transactions between source identifier(s) and destination identifier(s). The transactions are bundled into blocks and every block (except for the first block) refers back to or is linked to a prior block in the chain. Computer nodes maintain the blockchain and cryptographically validate each new block and thus the transactions contained in the corresponding block. This validation process includes solving a computationally difficult problem that is also easy to verify and is sometimes called a “proof-of-work.”

The integrity (e.g., confidence that a previously recorded transaction has not been modified) of the entire blockchain is maintained because each block refers to or includes a cryptographic hash value of the prior block.

Accordingly, once a block refers to a prior block, it becomes difficult to modify or tamper with the data (e.g., the transactions) contained therein. This is because even a small modification to the data will affect the hash value of the entire block. Each additional block increases the difficulty of tampering with the contents of an earlier block. Thus, even though the contents of a blockchain may be available for all to see, they become practically immutable.

The identifiers used for blockchain transactions are created through cryptography such as, for example, public key cryptography. For example, a user may create a destination identifier based on a private key. The relationship between the private key and the destination identifier can later be used to provide “proof” that the user is associated with the output from that created transaction. In other words, the user can now create another transaction to “spend” the contents of the prior transaction. Further, as the relationship between the destination identifier and the corresponding private key is only known by the user, the user has some amount of anonymity as they can create many different destination identifiers (which are only linked through the private key). Accordingly, a user's total association with multiple transactions included in the blockchain may be hidden from other users. While the details of a transaction may be publically available on the distributed ledger, the underlying participants to those transactions may be hidden because the identifiers are linked to private keys known only to the corresponding participants.

While blockchain technology has the potential to offer new benefits, it also poses problems for certain types of implementations. For example, one of the drawbacks of current blockchain technology implementations is inherent performance.

Traditionally, applications of blockchain use a single blockchain representing all transactions that occurred in a network. Since all transactions are recorded in a single blockchain, available technologies are not capable of scaling up to a level consistent with the requirements of applications such as micro-transactions and micropayments that are extremely high volume, with low economic value, and require close to real time execution.

In some cases the concept of sidechains has been implemented to link two or more networks. A side chain is a blockchain linked to another blockchain by interlocking the transactions, i.e., an element in one transaction in one blockchain points to an element in the transaction in another blockchain thus locking both in place and creating a connection at the point in which there is a passing transaction.

Each blockchain has its own validating authorities; these include miners or proof of work nodes, proof of stake, or consensus methods to establish the validity of a certain sequence of transactions and the status of the blockchain at a certain point in time.

Side-chained networks do not trust each other and just create a mechanism to inter-lock assets of the blockchain inside each other, thus making it possible to move assets across networks. This is a handy method but it's not performant or scalable, and does not provide fast settlement or scalability. Instead, side-chained networks are intended for representing or moving digital assets from one network to another, both of which use blockchain as the principle of operation (this could be either smart contracts (such as in the Ethereum network) or digital currency (as in the Bitcoin network)).

Sharding is currently being developed by some existing blockchains as a way to improve performance. Sharding is a mechanism by which some blocks in a blockchain do not need to be validated by all validators in the network, but rather each block is assigned to a sub-group of validators. Once validated by the group, the shard is added to the blockchain by a designated group of nodes.

Current implementations of blockchain are typically centered on registering transactions (i.e., movement of digital assets or contracts) in a single immutable structure as it refers to past events: the blockchain. As such, these networks have scalability issues.

Bitcoin (the most well-known implementation of the technology) can process, as of the time of writing, around 7 transactions per second with settlement times of 10 minutes. While many attempts are being made to mitigate these limitations, none has achieved the required speed and nimbleness required for high volume and fast settlement micro-transactions and micro-payments.

### SUMMARY

Embodiments disclosed herein provide a mechanism for high volume, very scalable transaction processing, advantageously facilitating close to real time settlement time. The disclosed systems and methods can be implemented on applications such as, but not limited to, all types of real time payments (macro, micro, nano) and asset management/exchange that use blockchain as the underlying technology.

Embodiments include a federated multi-blockchain structure. Separate cellular federations administer separate blockchains, with the collective federations acting like a single, coordinated blockchain that maintains the partitioned blockchain transactional information, thus allowing for greater scalability. In some embodiments, the systems and methods validate and route transactions within a federation and also validate and route transactions among multiple federations. The federations can constitute a geographically distributed and decentralized network. In some embodiments, federations store a partial blockchain representing transactions involving nodes in the federation, but no federation is required to store the totality of the transactions across the entire network in a single blockchain. The federations' blockchains may also include inter-federation aggregated transactions rather than detailed user transactions, and may also maintain the detailed user transactions as part of the aggregated transactions. Advantageously, some embodiments do not require a direct trust relationship between all federations in the network.

Some implementations include federations of users and a multilevel, hierarchical, federated inter-federation validation network. In some embodiments, users are assigned to a single federation based on one or multiple factors taken from, but not limited to: geographical location, population density, proximity to existing federation's users, interaction frequency, and affinity to other users of the system.

In some embodiments, transactions involving users of multiple federations are first validated at the source federation, and then routed to the destination federation where they are processed according to the specific business rules of the network. The destination federation may provide additional validation based on the network's business rules.

Embodiments include a computer-implemented method for accessing, developing, and maintaining a decentralized blockchain based database through a federated network, to preserve the original state of data inputs and transactional data while adapting to user preferences, changing circumstances, and emerging technological capabilities.

The methods and systems provide further functionality to: validate and route transactions; maintain and develop blockchain technology; create and maintain accounts; create and maintain user profiles; create, authenticate, and manage node membership; integrate 3rd parties in the form of SDKs and APIs in programming languages such as, but not limited to, C,C++,C #, JavaScript, Objective-C, Unity, UnReal, Swift, Java, Go, Python and in RPC methods such as, but not limited to, RestFull HTTP, HTTPS, HTTP/2, WebSocket, gRPC, TCP, P2P, RESP, UDP while contemplating future emerging programing languages and technologies.

Some embodiments include a blockchain method performed by a validator node of a first federation, the validator node including a transceiver and a processor, the method including: receiving, via the transceiver, incoming interfederation blocks (“IFBs”) from a second federation different than the first federation; validating the incoming IFBs to create validated IFBs; splicing the validated IFBs into validated transactions between payer-federation and receiver-federation pairs; merging the validated transactions based on the respective destinations of each validated transaction to create outgoing IFBs; proposing, to other validator nodes in the first federation, that an IFB of the outgoing IFBs be routed to a third federation different than the first federation and the second federation; and proposing, to other validator nodes in the first federation, that a transaction associated with the IFB of the outgoing IFBs be written to a blockchain.

In some embodiments, the second federation is a parent federation of the first federation and the third federation is a child federation of the first federation. In some embodiments, the second federation is a child federation of the first federation and the third federation is a parent federation of the first federation. In some embodiments, the second federation is a child federation of the first federation and the third federation is a child federation of the first federation.

In some embodiments, the incoming IFBs and outgoing IFBs include aggregated amounts of transactions between multiple federations.

In some embodiments, writing the transaction to a blockchain includes writing the transactions to a blockchain of the first federation, where the first federation's blockchain is different from a blockchain of the second federation and a blockchain of the third federation. In some embodiments, writing the transaction to a blockchain includes writing the payer-federations, the receiver-federations, and an aggregated transaction amount to the blockchain. In some embodiments, writing the transaction to a blockchain includes writing at least one of the outgoing IFBs to the blockchain.

Some embodiments further include broadcasting the outgoing IFBs to the receiver federations. In some embodiments, validator nodes determine the receiver federation by examining a recipient address in the IFB.

In some embodiments, the method further includes proposing, to other validator nodes in the first federation, that a second IFB of the outgoing IFBs be routed to a fourth federation different than the first federation, different from the second federation, and different form the third federation; and proposing, to other validator nodes in the first federation, that a transaction associated with the second IFB of the outgoing IFBs be written to the blockchain.

Some embodiments include a blockchain method performed by a validator node of a first federation, the validator node including a transceiver and a processor, the method including: receiving, via the transceiver, a transaction from a user node of the first federation; validating the transaction to create a validated transaction; determining if the validated transaction is an inter-federation transaction or an intra-federation transaction; in response to a determination that the validated transaction is an inter-federation transaction: merging, into an outgoing IFB, the validated transaction with other inter-federation transactions, proposing, to other validator nodes in the first federation, that the outgoing IFB be routed to a second federation different than the first federation, and proposing, to other validator nodes in the first federation, that the transaction be written to a blockchain; and in response to a determination that the validated transaction is an intra-federation transaction: proposing, to other validator nodes in the first federation, that the validated transaction be written to the blockchain.

Some embodiments include a multi-federation blockchain system including validator nodes, the multi-federation blockchain system including: a top level federation, middle level federations, and bottom level federations. The top level federation includes validator nodes, each validator node including a processor configured to: receive incoming IFBs from middle level federations; create outgoing IFBs from the incoming IFBs; route the outgoing IFBs to the middle level federations; and write transactions associated with the outgoing IFBs to a blockchain of the top level federation. The middle level federations include validator nodes, each validator node includes a processor configured to: receive incoming IFBs from the top level federation and bottom level federations; create outgoing IFBs from the incoming IFBs; route the outgoing IFBs to the top level federation and the bottom level federations; and write transactions associated with the outgoing IFBs to a blockchain of the middle level federation different from the blockchain of the top level federation. The bottom level federations include validator nodes, each validator node including a processor configured to: receive incoming IFBs from the middle level federations; receive transactions from user nodes of the respective bottom level federations; create outgoing IFBs from the transactions of the user nodes; route the outgoing IFBs to middle level federations; and write the transactions from the user nodes and transactions from the incoming IFBs to a blockchain of the bottom level federation different from the blockchain of the top level federation and different from the blockchain of the middle level federation.

In some embodiments, the system further includes membership federations having validator nodes, each validator node including a processor configured to assign validator nodes to one of the top level federation, middle level federations, and bottom level federations.

In some embodiments, the system further includes routing nodes, each routing node including a processor configured to broadcast transactions between bottom level federations. As used herein, “broadcasting a transaction” can be understood to include various types of messages. In some embodiments, “broadcasting a transaction” may include broadcasting the sender, the receiver, and the amount of the transaction. In some embodiments, when sending an instruction for a DAPP (such as reading the value stored in a variable or running a specific application), “broadcasting a transaction” may include a different type of message related to the DAPP. In some embodiments, a broadcast transaction is from a user node to a federation or between federations.

In some embodiments, the system further includes auditing nodes, each auditing node including a processor configured to monitor actions by the validator nodes for compliance with rules of the respective federations.

In some embodiments, the top level federation mints currency for the multi-federation blockchain system. In some embodiments, the processor of each validator node is configured to create an outgoing IFB by: validating the incoming IFBs to create validated IFBs; splicing the validated IFBs into validated transactions between payer-federation and receiver-federation pairs; and merging the validated transactions based on the respective destinations of each validated transaction to create the outgoing IFB. Some embodiments include a witness node of a first federation, the witness node including a processor configured to: validate the incoming IFBs of a second federation.

### BRIEF DESCRIPTION OF THE DRAWINGS

FIG. 1 is a schematic of a network topology in accordance with an embodiment.

FIG. 2 is a schematic of a federation Level 0 in accordance with an embodiment.

FIG. 3 is a diagram of an intra-federation transaction in accordance with an embodiment.

FIG. 4 is a diagram of an inter-federation transaction in accordance with an embodiment.

FIG. 5 is a flow chart of a method of assigning a user to a federation in accordance with an embodiment.

FIGS. 6A and 6B illustrate inter-federation blocks (“IFBs”) in accordance with an embodiment.

FIG. 7 is a flow chart of a method of validating IFBs in accordance with an embodiment.

FIG. 8A-FIG. 8H depict the progression of various transactions in a Federated Blockchain Network in accordance with an embodiment.

FIG. 9 illustrates an example of a computing device in accordance with one embodiment.

### DETAILED DESCRIPTION

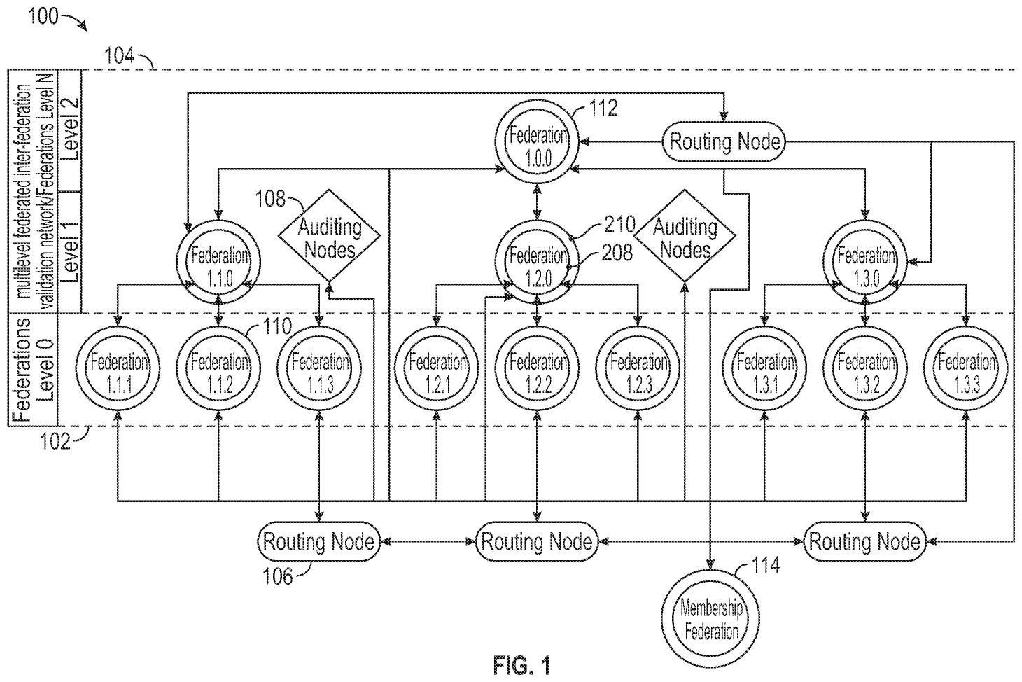

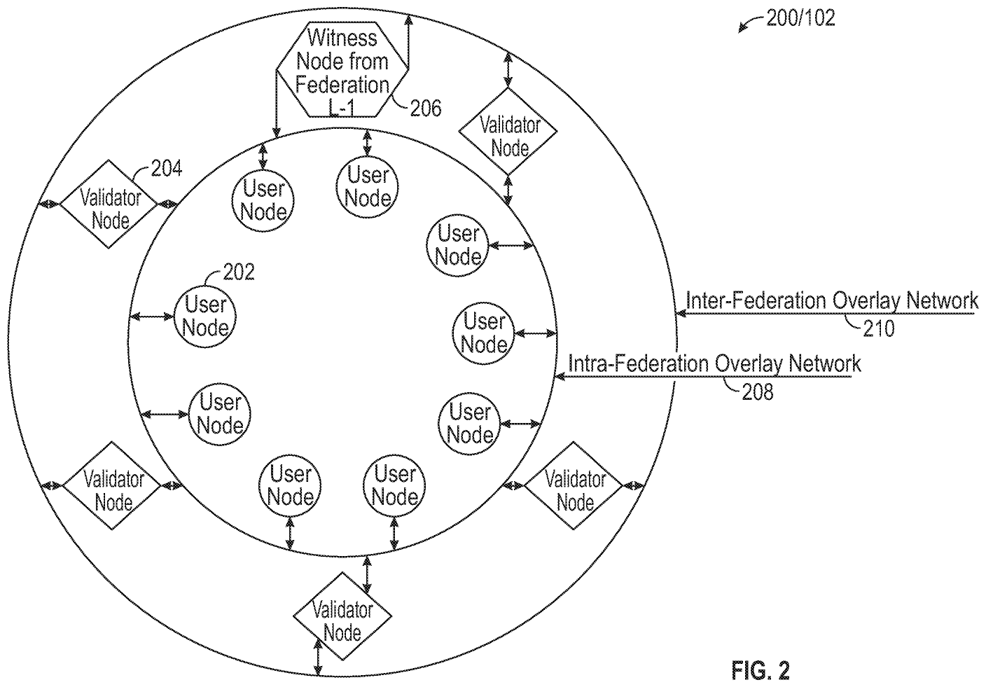

FIG. 1 is a schematic of a network topology 100 in accordance with an embodiment. Topology 100 represents the relationship between major components of a distributed blockchain network in some embodiments. In this example diagram, the network has 3 levels (for illustrative purposes only). The network is mainly comprised of nodes grouped in federations. The federations are organized in a hierarchical manner in a pyramidal or branching tree structure. To speed up the communication between federations across the network, Topology 100 implements Routing Nodes 106. All User Nodes 202 (see FIG. 2) interact with federations of Level 0. Federations of Level 1 to N (in this case 1 and 2) are part of the validation network that allows for the creation of a distributed multi-blockchain network.

Federations are depicted with two rings. Each Ring represents an Overlay Network 208/210 (see FIG. 2). In some embodiments, the federations of the Validation Network communicate using separate Overlay Networks 208/210 (see FIG. 2) with parents and with children federations. The “Federation Level 0 Diagram” 200 (see FIG. 2) has details on the Overlay Networks 208/210 (see FIG. 2) for the Federations Level 0 102.

Topology 100 includes multiple federations. Federations can allow a multi-level blockchain 100 to realize extremely fast transactions while maintaining the security and integrity of the blockchain with full traceability. The multi-level federation topology is like a Bidirectional Directed Acyclic Graph. Topology 100 depicts 3 types of federations: Federations Level 0 102, Federations Level 1 to Federations Level N 104, and Membership Federations 114.

Representing the multi-level federation structure as a tree 100, Level 0 federations 102 are the “leaf” of the tree. In these federations, User Nodes 202 (see FIG. 2) interact with Validator Nodes 204 (see FIG. 2) to exchange transactions. User Nodes 202 (see FIG. 2) are members of a Federation Level 0 200 and as such all their interactions with the network are done through interacting with a specific federation.

In some embodiments, Federations Level 1 to N validate inter-federation transactions, process the detailed data in such transactions to create new inter-federation transactions, and route those newly created transactions that include details of the original user transactions across the federations' hierarchy to the final recipient. As an example, Federation Level N will validate transactions between Federations Level N−1.

There can be zero, 1, or up to N degrees of separation between any Sender and any recipient. In the tree topology representation, degrees of separation are the distance from any federation to the closest common parent federation.

In some embodiments, Membership Federation 114 maintains a ledger containing each validator node membership and public cryptographic signature. In some embodiments, the Membership Federation 114 may also do one or all of the following: maintain in the ledger validator node credit worthiness or reputation and other implementation specific requirements; broadcast the membership ledger and changes to the ledger to federation nodes; maintain the membership ledger in a blockchain. The Validation Network could contain instructions that determine the rules for membership of nodes to federations. Such instructions can form a program and such program may be also run by the Membership Federation 114, thus modifying the blockchain and memberships over time.

There are multiple types of nodes interacting in a federation. For example, User Nodes 202, Validator Nodes 204, and Witness Nodes 206 (described below with respect to FIG. 2). In some embodiments, Routing Nodes 106 are responsible for routing user transaction between Federations Level 0 102 using high speed interconnected routes. Inter-federation transaction can be routed using multiple routing nodes until they reach the destination Federation Level 0 102. The routing algorithms may advantageously ensure that transactions are routed using the fastest path from the source Federation Level 0 102 to the destination Federation Level 0 102.

In some embodiments, Auditing Nodes 108 are responsible to silently and randomly audit Validator Nodes 204 (see FIG. 2) behaviors to setup the node's reputation. In some embodiments, the auditing node provides scores to validator nodes that can be used to scale in the validator node hierarchy. In some embodiments, the auditing node can lower the reputation of a validator node and prevent it from being promoted. The Auditing Nodes 108 are in charge of auditing the integrity of the entire distributed blockchain and the consistency of the transactions across all federations in the network. They have access to all the blockchains on all federations. The connections to the Overlay Networks 208/210 (see FIG. 2) are not shown for simplicity.

Advantageously, the auditing nodes may improve consistency of the entire (or a portion of) the distributed multi-blockchain across the network, and detect any double spending or other types of inconsistences or fraud. To do so, Auditing Nodes 108 verify the various federation's blockchains and make sure that all transaction are consistent, and that the entirety of the network (and all its distributed blockchains) behave as if the blockchain were a single blockchain on a single non-hierarchical network. The verification process depends on the embodiment of the network. When all transactions include detailed content, the Auditing Nodes 108 can optionally verify not just total values of transactions, but also the exact movement and location of all digital assets across the network. When, on the other hand, detailed information is limited to some federation levels, the Auditing Nodes 108 can optionally verify specific asset movements up to a specific point after which the level of auditing focuses only on total transaction values and types of the transferred assets. In cases for which transaction content details are not included at any level, the Auditing Nodes 108 are focused on verifying that the balances and transactions posted in each blockchain is consistent across the network and the total values transacted are correct. In cases where the pending transactions sent between two Federation Level Os have all the details of the digital assets transacted but IFBs do not include the details, the Auditing Nodes 108 can also recreate and verify not just total values, but also the exact movement and location of all digital assets.

FIG. 2 is a schematic of a Federation Level 0 in accordance with an embodiment. The “Federation Level 0 Diagram” 200 shows some details of a typical Federation Level 0 200. In the diagram there are 2 Overlay Networks 208/210. One dedicated to intra-federation transactions (the Intra-Federation Overlay Network 208) and another one dedicated to all communications of the federation with the rest of the Network (the Inter-Federation Overlay Network 210)

In some embodiments, User Node 202 belongs to a single Federation Level 0 200 that is selected and assigned when the user is first provisioned. Transactions created by the User's Node 202 are handled by the user's federation Validator Nodes 204. In some embodiments, the user node software can be executed from, but not limited to, a mobile device such as smartphone, a smartwatch, a set-top box, an IoT connected device, a dedicated computer on a data center, a virtual instance computer in a cloud service provider, an embedded computer device, etc.

In some embodiments, Validator Nodes 204 are responsible for validating transactions and recording such transactions in the blockchain. In some embodiments, each federation has a different set of active validator nodes responsible for all internal and inter-federation transaction validation and recording. Validator nodes membership to a federation and public signatures is maintained by the Membership Federation 114.

In some embodiments, validator nodes are reassigned periodically to a different federation based on a set of rules. In some embodiments, the reassignment is based on the reputation of the node. In some embodiments, the reassignment is based on node authority. In some embodiments, the assignment is based on node stake. The validator node participates in the consensus process which selects which validator node is responsible to propose the next block of transaction to add to the federation's blockchain.

Some embodiments implement Witness Nodes 206. These nodes are members of the parent Federation level N+1 104 and participate in the Federation level N 104. The role of the witness node is to participate in the validations of the transactions approved by the child Federation Level N−1's validator nodes. Witness nodes can also participate as validator nodes in the transactions of the federation to which they belong.

In some embodiments, User Nodes 202 interact with the federation via the Intra-Federation Overlay Network 208. The Intra-Federation Overlay Network 208 can be used to broadcast all transactions from User Nodes 202 and to User Nodes 202 and for all communications by Validator Nodes 204 (and the optional Witness Node 206) for internal federation purposes.

In some embodiments, Validator Nodes 204 and the Witness Node 206 interact with the parent federation via the Inter-Federation Overlay Network 210. The same is true when broadcasting or receiving broadcasted transactions from other Federations Level 0 102. The Routing Nodes 106 facilitate this communication.

A User Node 202 can create a transaction with destination to any other User Node 202 regardless of the Federation Level 0 102 of the destination.

In some embodiments, when a user wants to create a new transaction it first has to broadcast it to its federation's Validator Nodes 204. The software on the User's Node 202 discovers the address of its federation's Validator Nodes 204 and broadcasts the transaction to it. In some embodiments, the sender always sends outgoing transactions through its federation, regardless of the actual federation of the destination. In some embodiments, If the destination address belongs to a different federation, an inter-federation transaction is broadcasted to the destination federation through a routing node, and the hierarchical validation process is triggered.

Transactions are validated at multiple stages by Validator Nodes 204. In some embodiments, transactions can be validated in one, or several of the following ways: transactions are validated for integrity, transactions are cryptographically validated by asserting its signatures, transactions are validated for double spending, transactions are validated for over spending, the transaction's payload is validated based on the business rules represented by the transaction, source address and destination address. In case of inter federation transactions, the valid cryptographic signatures are stored by the Membership Federation 114.

Valid transactions are proposed to be part of the next block. Invalid transaction that failed validation are proposed to be discarded. This may be done when, for example, the balance of the sender is not sufficient to complete the requested transaction.

In some embodiments, each transaction has a structure that includes the full routable address of the sender and the receiver and can also include the IDs of each of the tokens or each digital asset being transferred in such transaction.

A parent federation of Federation A of level N 104 can be understood to be the Federation Level N+1 directly connected to the Federation Level N. In the Network Topology Diagram 100 we can see for example that the parent of Federation 1.1.2 110 is Federation 1.1.0 112. Note: this document uses a naming convention to refer to federations and federations' locations in the network; it should be understood that this naming convention does not limit the naming options and is adopted only for ease of reference.

Federations have addresses based on the ID of all federations that create the shortest route from the user's node federation all the way to the highest level federation (the top federation) based on the network topology (see Network Topology diagram for an example of how this naming convention is applied to the network in the diagram). If the federation is Level N>0 then all digits to the right of the Nth digit are zero.

For example (but not by way of limitation), for a 6 levels federation, the top federation's address is 1.0.0.0.0.0 and a transaction could be:
From: 1.2.6.50.33.987.USER_NODE_ID_SENDER
To: 1.2.86.34.76.85.USER_NODE_ID_RECEIVER
Summary Value and Properties
Content: Digital Asset_ID1, Digital Asset_ID2, Digital Asset_ID3, . . . , Digital Asset_IDn
Other transaction information: embodiment specific

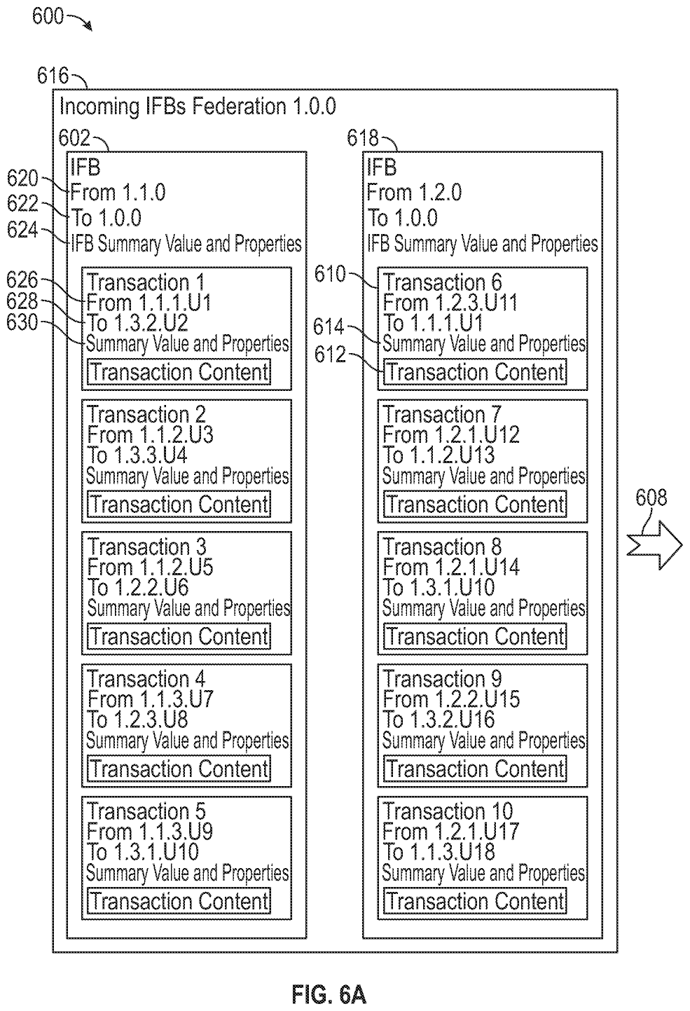

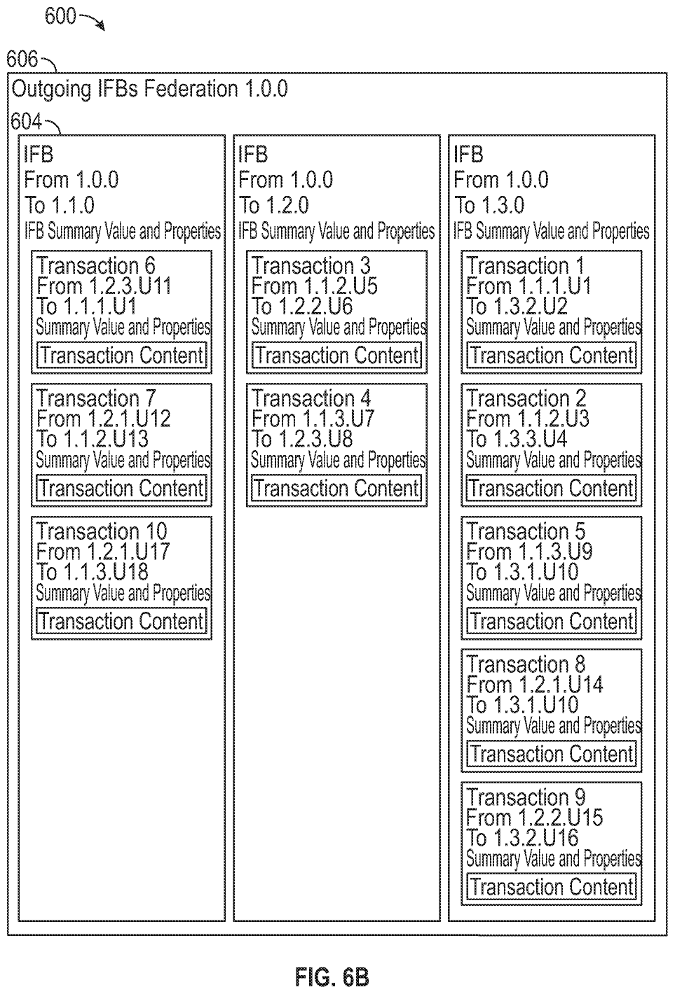

FIGS. 6A & 6B illustrate inter-federation blocks (“IFBs”) in accordance with an embodiment. IFBs 600 assume, for illustrative purposes, a network with the same federation structure as in the Network Topology Diagram 100 and a specific embodiment of IFBs. IFBs 600 are exemplary. FIGS. 6A & 6B illustrates (a) the incoming broadcasted transactions to a Federation 602 that have been validated and will become the source of transactions for the next block of such federation, (b) the details of the content of such broadcast, including the IFBs and its parts 602/618, and (c) the resulting output from such broadcast, i.e., the newly formed IFBs 604 to be broadcasted to other federations and to be written as the next block 606 in the federation's blockchain.

Grouped, on the left, are all broadcasted IFBs received by the top federation from all the children federation 616. In the example, only 2 of the 3 children have broadcasted an IFB 602/618. The diagram also shows the main data components of the IFB, including the Sender Federation 620 and the Receiver Federation 622, as well as the summary values for the totality of the IFB 624. In addition, FIGS. 6A & 6B show the Transactions 610 contained in each of the two incoming IFBs. Each transaction includes a Sender 626 and a Receiver 628 as well as the summary values and properties of such Transaction 630. In this embodiment, transactions in the IFB include also the Transaction Content 612, i.e., the details of all digital assets included in the transaction.

On the right, FIGS. 6A & 6B show the output IFBs 604, with the corresponding transactions according to the transaction's receiver. These IFBs are obtained once the federation has processed 608 the incoming IFBs. The output IFBs 604 are going to be broadcasted to the appropriate federation and will be written as a new block 606 in the federation's blockchain.

Transactions 610 can have various levels of detail (content) depending on the embodiment and requirements of the implementation. Some of the options listed below depict some (but not all) embodiments of the transaction details. In some embodiments, Transactions 610 include the detailed list of individual Assets 612 being transferred in the transaction. In some embodiments, assets included in the transaction are entered with specific asset properties that include but are not limited to: asset value, asset use rights, asset use restrictions, asset valid use dates, etc. In some embodiments, transactions don't include the detailed list of individual assets being transferred. Instead transactions include a summary of the transaction value. Such embodiments may be advantageous when it's not required or not important to identify individual assets, i.e., when there are many equal interchangeable (fungible) assets with equal or similar properties and/or values. In some embodiments, transactions include a Summary 614 of the transaction value and also transaction use rights, transaction use restrictions, transaction valid use dates, etc. Transactions can have different contents depending on the federation level that is sending and receiving the transaction. For example, in some embodiments, a transaction broadcasted “sideways” as a pending transaction from a Federation Level 0 102 to another Federation Level 0 102 can have details on all digital assets being transferred, and the same transaction when broadcasted from the same Federation Level 0 102 to the parent Federation Level 1 104 can have only summary level information.

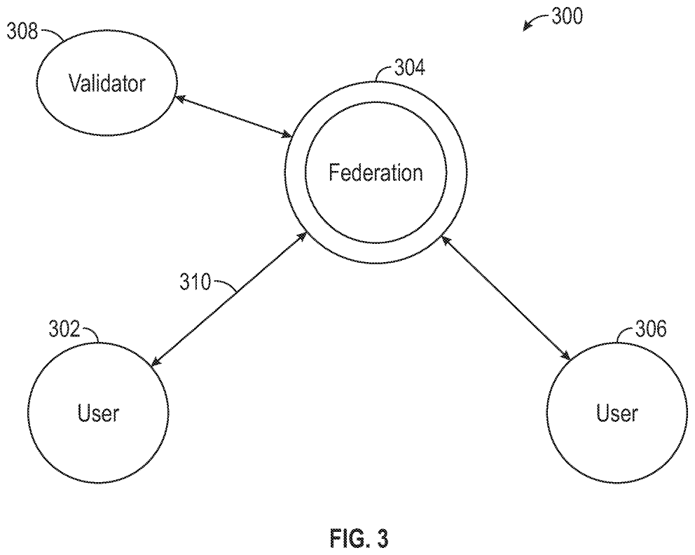

FIG. 3 is a diagram of an intra-federation transaction in accordance with an embodiment. The users associated with User Node 302 and User Node 306 are members of the same Federation Level 0 200 (see FIG. 2), in such case no transactions occur across federations. The entirety of the process is managed within the blockchain of the Federation Level 0-A and the process ends there. User 302 forwards a Transaction 310 with destination to User 306, to its Federation 304 through the Validator Node 308 (see also, Validator Nodes 204 peers at Federation Level 0-A in FIG. 2). The Validator Node 308 validates the Transaction 310 and proposes it to be part of the next block of the blockchain of Federation 304 (see also, Validator Nodes 204 of the Federation Level 0-A validate the transaction and add the transaction to the next block in FIG. 2). When the Transaction 310 is confirmed in the blockchain of Federation 304 (e.g., the block is signed and proposed to the federation; if accepted, by any of the consensus means or any other mean, it becomes the new block of the federation's Level blockchain), User 306 can perform any business logic associated with the Transaction 310.

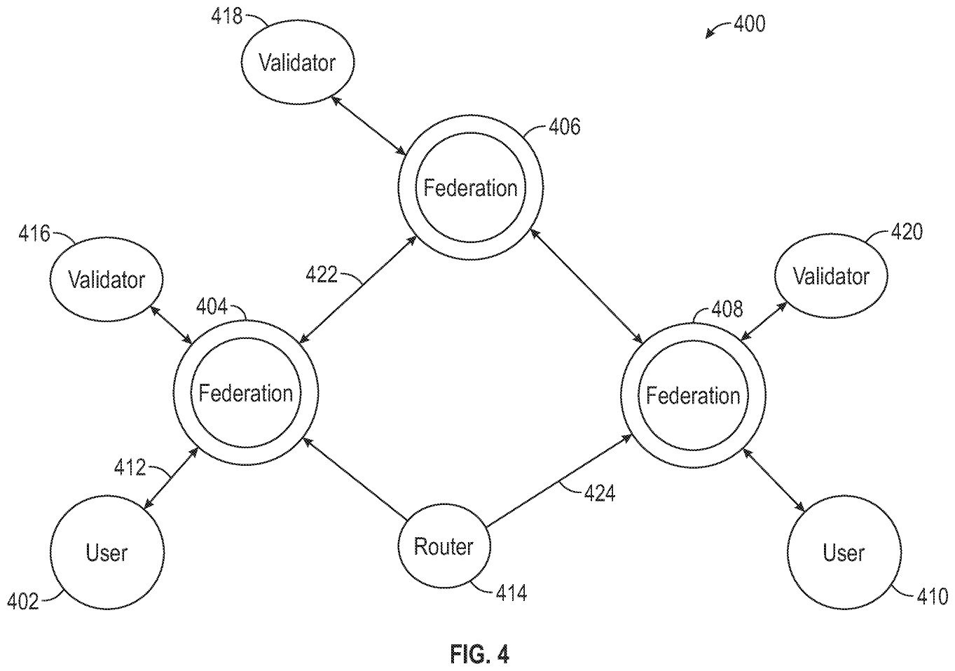

FIG. 4 is a diagram of an inter-federation transaction in accordance with an embodiment. User Node 402 and User Node 410 belong to a different Federation Level 0 200 (e.g., Federation Level 0-A and Federation Level 0-B respectively). User 402 forwards a Transaction 412 with destination to User 410 to its Federation 404 through the Validator Node 416 (e.g., User Node A sends a transaction to its Validator Nodes 204 peers at Federation Level 0-A in FIG. 2). The Validator Node 416 proposes the Transaction 412 to be inserted in the next block (e.g., the Validator Nodes 204 of the Federation Level 0-A in FIG. 2 validate the transaction and add the transaction to the next block). Once the Transaction 412 is part of the Federation 404 blockchain (e.g., the block is signed and proposed to the federation; if accepted, by any of the consensus means or any other mean, it becomes the new block of the Federation's Level 0-A blockchain), the Router Node 414 (e.g., Router Nodes 106 in FIG. 1 between the two federations route the transaction from Federation Level 0-A to Federation Level 0-B; if no routing nodes exists, the transaction is only sent through the Validation Network as described below) forwards the Transaction 424 to the destination Federation 408 where Validator Node 420 validates it (e.g., as soon as received, the Validator Nodes 204 of Federation Level 0-B post validate the transaction based on several optional business rules or embodiments: (a) Validate the signatures in the transaction, (b) Validate the transaction with the witness in Federation Level 0, or (c) Other) and propose it for Federation 408 next block (e.g., the Validator Nodes 204 of Federation Level 0-B enter the transaction in the next block of the Federation Level 0-B blockchain in a status that depends optional business rules or embodiments: (a) The transaction is entered as “Settled” and (b) The transaction is entered as Pending. If the transaction is entered as “Pending,” the status of the transaction is changed to “Settled” by a new entry in the blockchain only after the Validation Network Process has been completed as explained below). In parallel, the hierarchical validation process is triggered by forwarding the signed Transaction 422 to the upper Federation 406 as part of an inter-federation transaction, where Validator Node 418 validates it to be proposed as part of Federation 418 next block. User 410 can perform the associated business logic when either or both Transactions 424 and 422 are confirmed as part of Federation 408 blockchain or any other combination associated with the business logic of the services associated with the original Transaction 412.

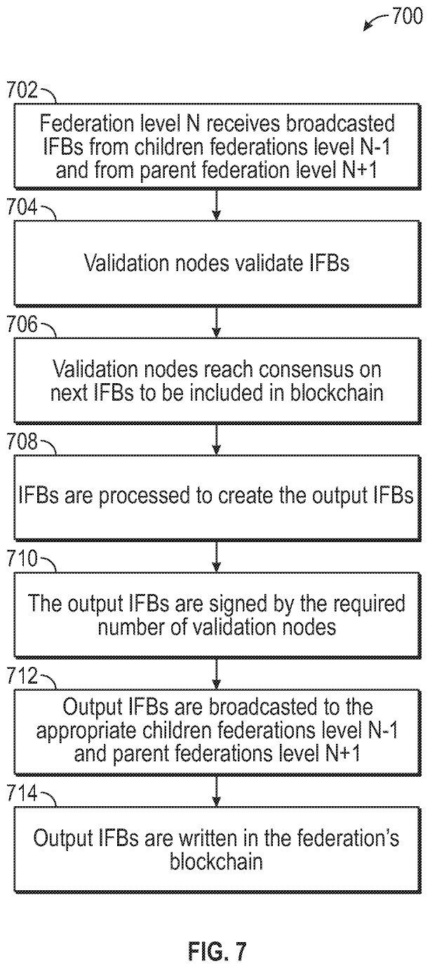

FIG. 7 is a flow chart of a method of validating IFBs in accordance with an embodiment. The “Validation Flow Diagram” is a block diagram of the main processes used by each Federation Level N 104 in the validation network to create a distributed multi-blockchain network. Each of the blocks in the diagram represents a process that has several embodiments. The various embodiments of each process can be a function of the business rules necessary for a specific implementation.

Transaction validations are performed by Validator Nodes 204 (see, e.g., FIG. 2) in each federation through various means. In some embodiments, transactions can be validated in one, or several of the following ways: transactions are validated for integrity, transactions are cryptographically validated by asserting its signatures, transactions are validated for double spending, transactions are validated for over spending, the transaction's payload is validated based on the business rules represented by the transaction, source address and destination address.

Validated transactions are proposed to be part of the next block. If consensus is reached, the transaction is added to the block. Multiple consensus algorithms can be applied based on the federation level. Consensus can be reached using multiple methodologies and algorithms such as, but not limited to, proof of stake, proof of work, proof of authority, proof of trust, proof of credentials, reputation, and others.

Some embodiments optionally use various types of blocks. Federations Level 0 200 process 2 types of transactions (a) intra federation transactions: these are transactions that happen between two User Nodes 202 of the same Federation Level 0 200; (b) Inter Federation Blocks (IFBs) 602/618 (see FIGS. 6A & 6B): these are blocks that only contain transactions that have as destination (recipient) User Nodes 202 of a different Federation Level 0 200. In some embodiments, Federations Level>0 104 only create IFBs. IFBs are implemented in some embodiments but other strategies could be used, including no transaction grouping for broadcasting purposes, i.e., instead of having IFBs, individual transactions could be routed through the Validation Network, but this approach may hinder scalability. In some embodiments, the IFBs are inserted into a blockchain. In some embodiments, the IFBs are different than the blocks inserted into a blockchain. For example, in some embodiments, IFBs comprise metadata associated with transactions. In some embodiments, one channel sends summary transaction data and another channel sends detailed transaction data. This may advantageously allow fast transaction speeds while maintaining block chains with all details of each transaction. In some embodiments, the summary data and detailed data are linked with a hash of the detailed data.

IFBs are created by all federations according to the established business rules of each specific embodiment. Some examples of embodiments are: IFBs are created with a certain frequency; IFBs are created based on the proposal of a specific node that can be selected using various selection rules, etc.

Once IFBs are created, they are cryptographically signed and broadcasted to the parent federation and the children federation according to the IFB's destination address.

In FIG. 7 again, process 700 begins at step 702 when a Federation Level N 104 receives IFBs 602 from its children federations (IFBs Level N−1) and/or from the parent Federation Level N+1 (IFBs Level N+1; this doesn't happen for the top level federation as it has no children federations). At Step 704, all IFBs Level N−1 and IFBs Level N+1 are validated by the receiving federation. There are several options to complete an IFB validation (or a combination or any of the following, but not limited only to the following): (a) the validation checks that there are the required number of signatures, (b) the validation includes that the IFBs Level N−1 are signed by the witness nodes, (c) the validation requires that the IFBs Level N−1 have been already written into the children federation sending the IFB 602, (d) the validation requires that the IFB Level N+1 has been already written into the parent federation sending the IFB 602, (e) the validation requires to check for double spending in the Federation N blockchain (This can be done on more than one way: (i) The double spending can be checked at a detailed level, looking at the token ID of each of the tokens that is being submitted in each transaction and making sure that these tokens have entered the Federation Level N−1 in the past by means of another transaction and did not leave the Federation Level N−1 since the last time such token entered the Federation Level N−1 or, (ii) The double spending can be checked at a summary level when it's not required or not important to identify individual assets, i.e., when there are many equal interchangeable assets with equal properties and/or values. Checking double spending at the summary level may mean checking the total balance of assets available to all children federations of the Federation Level N−1 that is being verified have sufficient assets to complete the transaction. The total assets available to such Federation Level N−1 will be registered and available to the Federation Level N 104 by looking at all previous transaction of the Federation Level N−1 on the blockchain of the Federation Level N 104 doing the verification. In some embodiments, such balance will be added to the last transaction to improve the performance of the system.).

If an IFB 602 cannot be validated it is ignored and in some embodiments it's also sent back to the sender as invalid, discarded and broadcasted back to the originating federation. An IFB may be discarded when, for example, the balance of the sender is not sufficient to complete the requested transaction. An IFB may be broadcast back when, for example, the destination of the transaction doesn't exist (e.g., the transaction's destination is a non-existent federation).

Once the nodes of Federation N have validated the incoming IFBs 602, at Step 706, the consensus process is activated to decide which IFBs 604 are going to be part of the next block. As mentioned before, each new block 606 can be comprised by several (or all) IFBs received 602 since the last block consensus was reached.

All IFBs Level N−1 602 and IFBs Level N+1 validated and selected for the next block 606 are separated into the component individual transactions. At Step 708, the transactions 610 of all IFBs are then sorted by destination and a new set of IFBs 604 is created 708. The new IFBs 604 (IFBs Level N) are based on the parent or child destination of each transaction. At Step 710, each new IFB Level N 604 is then cryptographically signed by a minimum required number of validator nodes at Federation Level N 104. In some embodiments, the total required Validator Nodes 204 varies based on a reputation score given to each node, in which case the minimum required can be a minimum total reputation score. In other embodiments, the total required can be based on the stake of the nodes that participate in the validation at the federation. In that case, the requirement may be a minimum total stake of all Validator Nodes 204. In other embodiments, there are some authoritative required nodes that have to participate in the validation while others are optional. Optionally, in some embodiments, the IFB Level N 604 destined for the parent federation is also signed by the Witness Node 206 of the parent and it's considered a required authoritative node.

Once the required signatures validating the IFBs have been collected, at Step 712 all the IFBs Level N 604 are routed (and broadcasted) to the appropriate federation destination (Children Federations Level N−1 and the Parent Federation Level N+1) based on a criterion that can include but it's not limited to: a certain frequency, frequency and volume, frequency and credit worthiness or reputation, immediately as a block is validated by the Federation Level N 104, or a combination of the foregoing criteria.

After broadcasting the IFBs 604 to the proper destinations, at Step 714 all IFBs Level N 604 are added in a new block 606 to the Federation Level N blockchain. The individual transactions in the IFB don't need to be stored in the federation blockchain (only the summary) but they have to be broadcasted. The sequence can be reversed also, i.e., the IFBs can be first stored in the blockchain and only then broadcasted.

The same validating process 700 described above is repeated across the entire network for all Federations Level N 104.

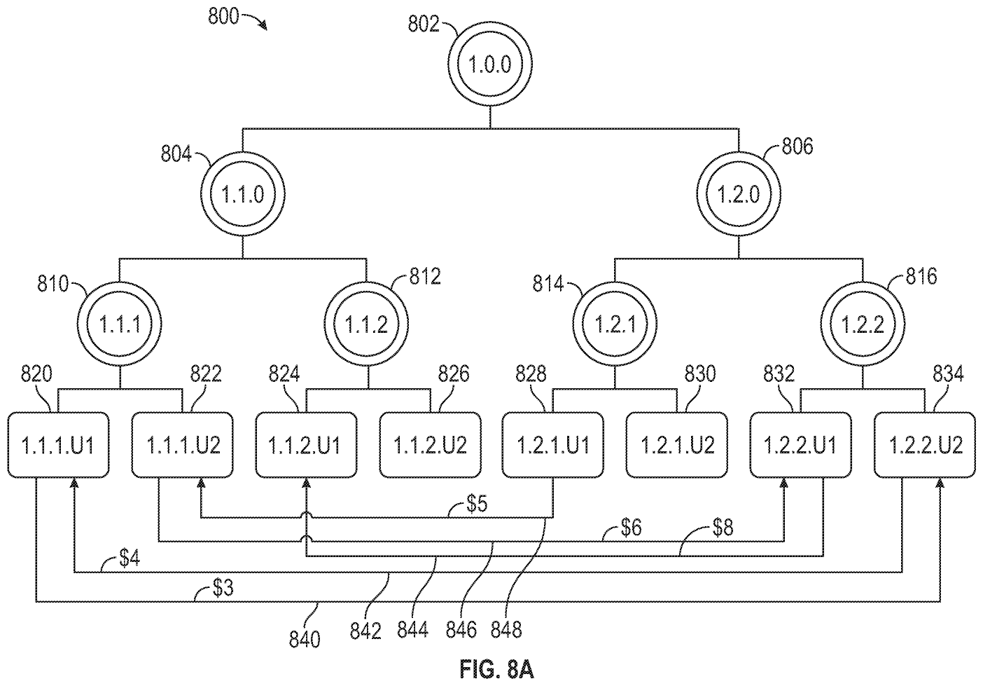

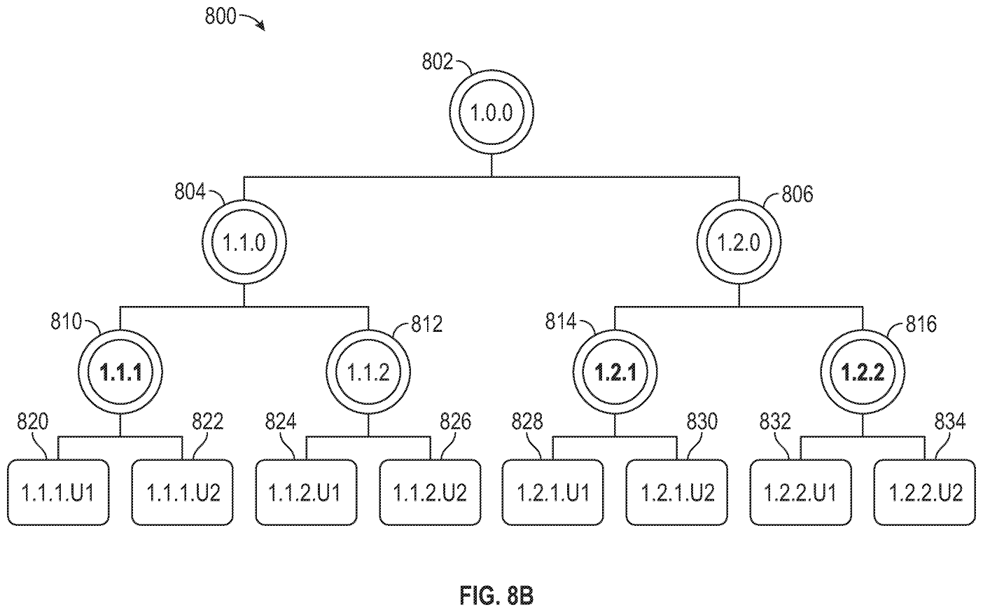

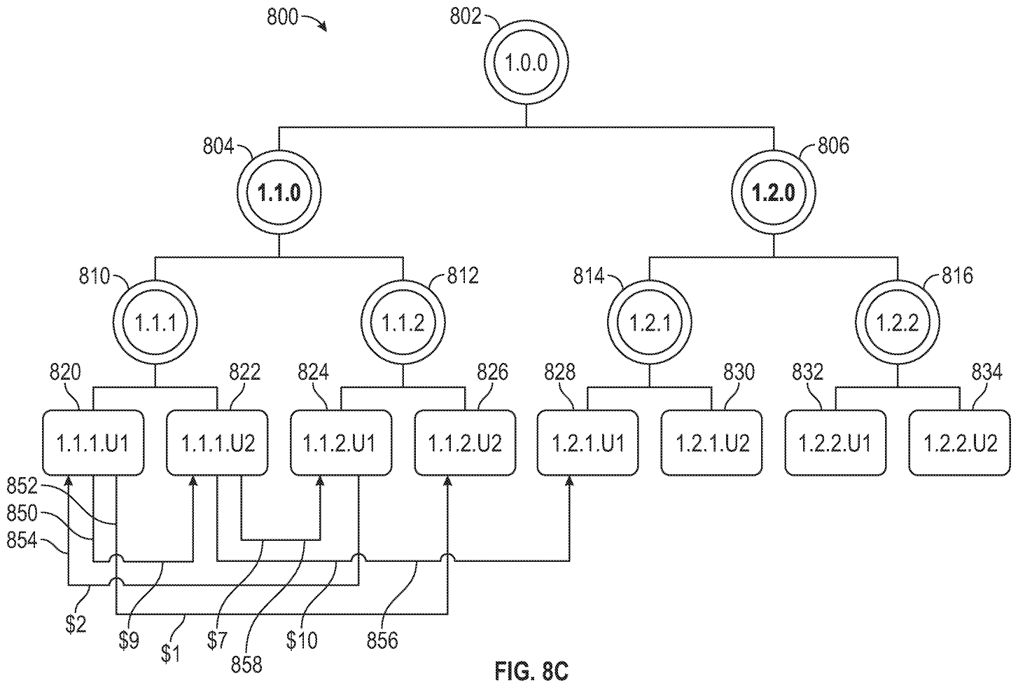

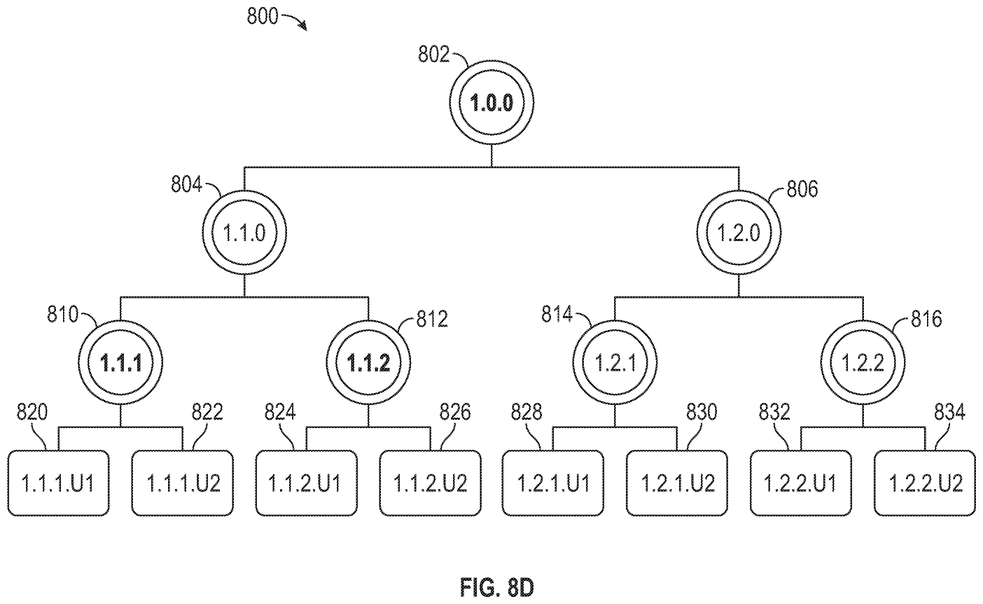

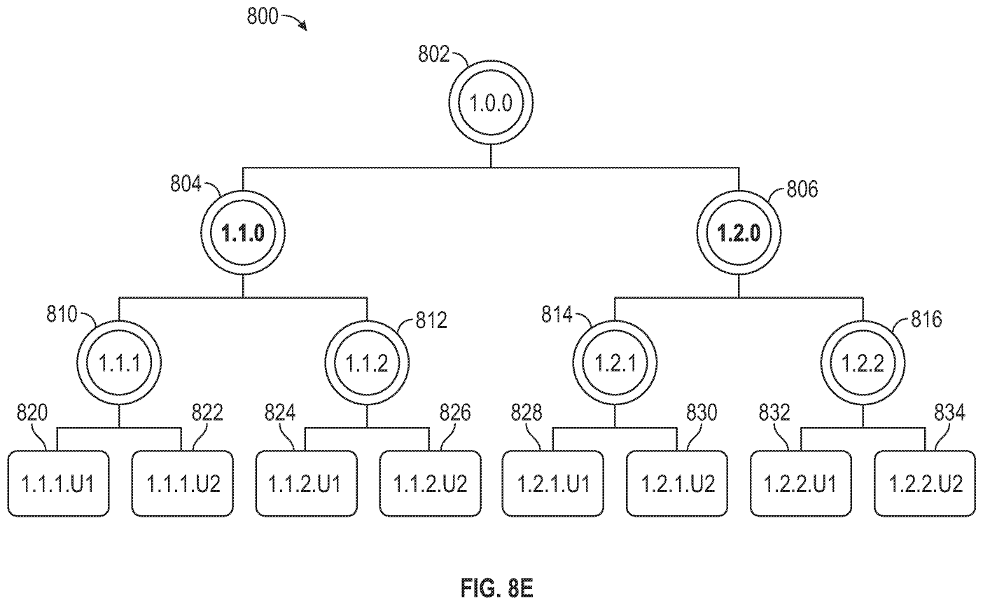

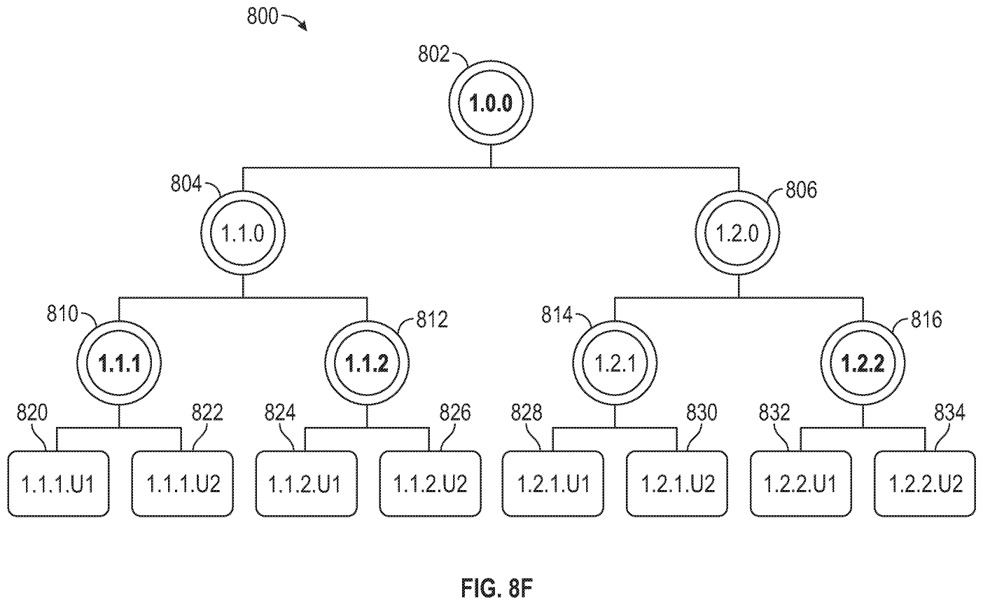

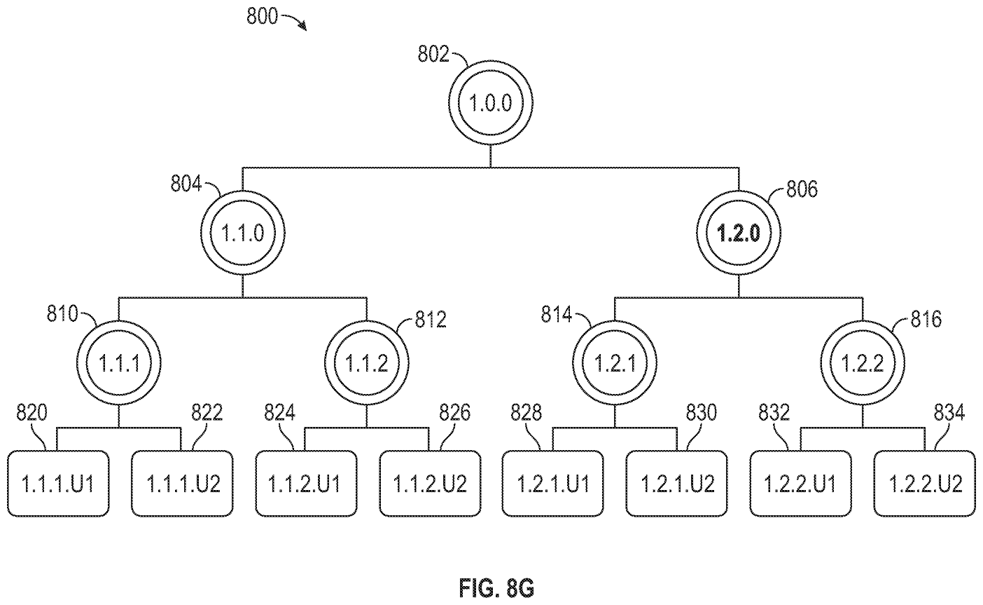

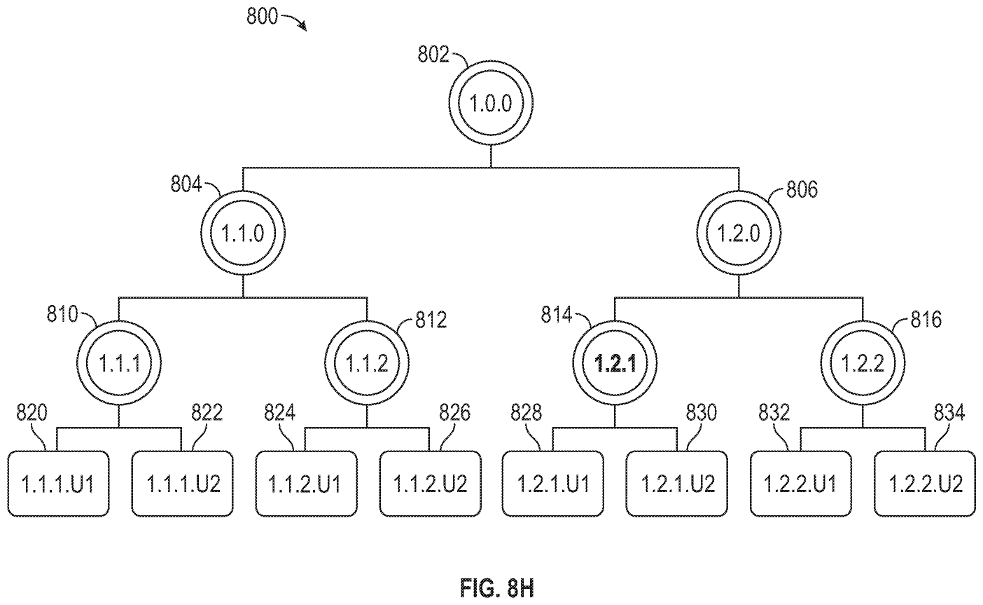

FIGS. 8A-8H depict the progression of various transactions in a Federated Blockchain Network 800 in accordance with an embodiment. Network 800 includes Top Level Federation 802, Middle Level Federations 804 and 806, and Bottom Level Federations 810, 812, 814, and 816. Each federation of the Multi-Federation Network 800 includes validator nodes (not shown). Bottom level federations include user nodes: Bottom Level Federation 810 includes User Nodes 820 and 822, Bottom Level Federation 812 includes User Nodes 824 and 826, Bottom Level Federation 814 includes User Nodes 828 and 830, and Bottom Level Federation 816 includes User Nodes 832 and 834. In FIGS. 8A-8H, user node transactions are depicted by arrows and federation processing (IFBs or transactions) is depicted by bold highlighting. FIGS. 8A-8H show transactions originating at user nodes and moving through the Network 800.

In some embodiments, Top Level Federation 802 is Federation 1.0.0 discussed in FIG. 1 or Federation 406 described above with respect to FIG. 4. Although FIG. 8 illustrates Top Level Federation 802 as the only top level federation, other embodiments include additional federations at the same level as Top Level Federations. In some embodiments, Middle Level Federations 804 and 806 are Federations 1.1.0, 1.2.0, and 1.3.0 discussed above with respect to FIG. 1. Although FIGS. 8A-8H depict a single level of middle level federations, it should be appreciated that there may be many levels of middle level federation. In some embodiments, Bottom Level Federations 810, 812, 814, and 816 are Federations 1.1.1, 1.1.2, 1.1.3, 1.2.1, 1.2.2, 1.2.3, 1.3.1, 1.3.2, and 1.3.3 described above with respect to FIG. 1, Federation 200 described above with respect to FIG. 2, Federation 304 described above with respect to FIG. 3, or Federations 404 and 408 described above with respect to FIG. 4.

Network 800 may optionally include membership federations (not shown). For example, validator nodes of the membership federation may include processors configured to assign validator nodes to one of the top level federation, middle level federations, and bottom level federations.

Network 800 may optionally include routing nodes (not shown). For example, routing nodes may include processors configured to broadcast transactions between bottom level federations.

Network 800 may optionally include auditing nodes (not shown). For example, auditing nodes may include processors configured to monitor actions by the validator nodes for compliance with rules of the respective federations.

In some embodiments, the top level federation mints currency for the multi-federation blockchain system.

In some embodiments, a processor of a validator node in Network 800 is configured to create an outgoing IFB (see, e.g., IFB 604 in FIGS. 6A & 6B) by validating the incoming IFBs (see, e.g., IFB 602 in FIGS. 6A & 6B) to create validated IFBs, splicing the validated IFBs into validated transactions between payer-federation and receiver-federation pairs, and merging the validated transactions based on the respective destinations of each validated transaction to create the outgoing IFB. Some further embodiments may include a witness node (not shown) for a first federation that includes a processor configured to validate the incoming IFBs of a second federation.

Turning now to FIG. 8A, the process begins when user nodes of the bottom level federations transfer digital currency or assets (or other representations of value) between each other: User 820 of Federation 1.1.1 (Federation 810) transfers $3 (represented by arrow 840) to User 834 of Federation 1.2.2 (Federation 816), User 822 of Federation 1.1.1 (Federation 810) transfers $6 (represented by arrow 846) to User 832 of Federation 1.2.2 (Federation 816), User 828 of Federation 1.2.1 (Federation 814) transfers $5 (represented by arrow 848) to User 822 of Federation 1.1.1 (Federation 810), User 832 of Federation 1.2.2 (Federation 816) transfers $8 (represented by arrow 844) to User 824 of Federation 1.1.2 (Federation 812), and User 834 of Federation 1.2.2 (Federation 816) transfers $4 (represented by arrow 842) to User 822 of Federation 1.1.1 (Federation 810).

FIG. 8B depicts bottom level federations processing the transactions depicted in FIG. 8A. The validator nodes of each bottom level federation process the transactions according to the rules of each federation. In some embodiments, the bottom level federation validator nodes include processors configured to receive incoming IFBs from the middle level federations, receive transactions from user nodes of the respective bottom level federations, create outgoing IFBs from the transactions of the user nodes, route the outgoing IFBs to middle level federations, and write the transactions from the user nodes and transactions from the incoming IFBs to a blockchain of the bottom level federation different from a blockchain of the top level federation and different from a blockchain of the middle level federation. In the example of FIG. 8B, the bottom level federations receive transactions from user nodes in the respective federations (i.e., the bottom level federations did not receive IFBs from middle level federations in FIG. 8A).

In some embodiments, bottom level federation validator nodes include a transceiver and a processor. Each validator node performs a method which includes receiving, via the transceiver, a transaction from a user node of the bottom level federation. The validator node validates the transaction to create a validated transaction. Next, the validator node determines if the validated transaction is an inter-federation transaction or an intra-federation transaction. In response to a determination that the validated transaction is an inter-federation transaction, the validator node merges (into an outgoing IFB) the validated transaction with other inter-federation transactions, proposes (to other validator nodes in the bottom level federation) that the outgoing IFB be routed to a middle-level federation different, and proposes (to other validator nodes in the bottom level federation) that the transaction be written to a blockchain. In response to a determination that the validated transaction is an intra-federation transaction, the validator node proposes (to other validator nodes in the bottom level federation) that the validated transaction be written to a blockchain.

In FIG. 8B, Federation 810 receives Transactions 840 and 846 originating from Users 820 and 822, respectively. Validator nodes in Federation 810 determine that Transactions 840 and 846 are inter-federation transactions and so merge (after validation) those transactions into IFBs for Federation 804. Similarly, Federation 814 merges Transaction 848 into IFBs for Federation 806 and Federation 816 merges Transactions 842 and 844 into IFBs for Federation 806. In some embodiments, each validator node of a federation validates an IFB, then the validator nodes of the federation reach consensus before any validator node begins splicing and merging. In some embodiments, each validator node validates an IFB, splices the IFB, and merges into an outgoing IFB(s) before reaching consensus with other validator nodes of its federation. In some embodiments, a validator node receives an IFB from a second federation through a peer validator node in its own federation. In some embodiments, a validator node relays an IFB to peer validator nodes in its own federation. In some embodiments, transaction details are sent separately from IFBs (either between peer validator nodes or between federations). In some embodiments, a validator node of a federation receives an (or an IRB and transaction) and then propagates it to the rest of the validators in the federation. The validator that proposes the next block to the rest of the validators in the federation is decided based on some rule (could be a “round robin” or other rule) and that validator node proposes to add the block, but all other validators repeat the same job before accepting the proposal.

FIG. 8C depicts middle level federation validator nodes processing IFBs received from the bottom level federations in FIG. 8B and depicts additional transactions between user nodes in the bottom level federations. In FIG. 8C, User 820 of Federation 1.1.1 (Federation 810) transfers $9 (represented by arrow 850) to User 822 of Federation 1.1.1 (Federation 810), User 820 of Federation 1.1.1 (Federation 810) transfers $1 (represented by arrow 852) to User 828 of Federation 1.2.1 (Federation 814), User 822 of Federation 1.1.1 (Federation 810) transfers $7 (represented by arrow 858) to User 824 of Federation 1.1.2 (Federation 812), User 822 of Federation 1.1.1 (Federation 810) transfers $10 (represented by arrow 856) to User 828 of Federation 1.2.1 (Federation 814), and User 826 of Federation 1.1.2 (Federation 812) transfers $2 (represented by arrow 854) to User 820 of Federation 1.1.1 (Federation 810). These additional transactions may be processed in the same way as the transactions of FIG. 8A.

Middle level federation validator nodes include processors configured to receive incoming IFBs from the top level federation and bottom level federations, create outgoing IFBs from the incoming IFBs, route the outgoing IFBs to the top level federation and the bottom level federations, and write transactions associated with the outgoing IFBs to a blockchain of the middle level federation different from the blockchain of the top level federation. In FIG. 8C, Middle Level Federation 804 receives IFBs only from Bottom Level Federation 810 and Middle Level Federation 806 receives IFBs only from Bottom Level Federations 814 and 816 (because these were the only federations where transactions originated in FIG. 8B). In some embodiments, a middle level federation receives/sends IFBs from/to any combination of its parent federation and children federation(s).

In some embodiments, middle level federation validator nodes include a transceiver and a processor. Each validator node performs a method which includes receiving, via the transceiver, incoming interfederation blocks (“IFBs”) from a different federation (in FIG. 8C, Federation 804 receives IFBs from Federation 810 and Federation 806 receives IFBs from Federations 814 and 816). The validator nodes then repackage the received IFBs as outgoing IFBs. In some embodiments, repackaging received IFBs includes validating the incoming IFBs to create validated IFBs, splicing the validated IFBs into validated transactions between payer-federation and receiver-federation pairs, and merging the validated transactions based on the respective destinations of each validated transaction to create outgoing IFBs. The validator nodes may propose (to other validator nodes in its federation) that an IFB of the outgoing IFBs be routed to a federation(s) different than its own federation and the federation from where the IFB originated and/or propose (to other validator nodes in its federation) that a transaction associated with the IFB of the outgoing IFBs be written to a blockchain.

In some embodiments, incoming IFBs and/or outgoing IFBs include aggregated amounts of transactions between multiple federations. In such embodiments, the IFBs may include reduced information sufficient to maintain security while improving speed. For example, the IFBs may include the originating federation, the destination federation, and aggregated transaction amounts. In some embodiments, the IFBs includes the recipient (including the destination federation address) and the amount transferred. In some embodiments, the IFBs also include the sender and/or the asset type.

In some embodiments, the assets are aggregated by type. If the assets are not fungible but still of the same type, some embodiments aggregate the totals (asset ID may be an important piece of info in the metadata). Some embodiments ensure that the correct asset is credited at the end of the process in the Federation Level 0 of the recipient.

In some embodiments, the info for the type of asset that appears in the metadata is stored in each of the Federations that took part in routing the asset. This may enhance security. For example, for sending real estate property titles with increased security, some embodiments store the metadata sent in the IFB in each federation.

In some embodiments, writing the transaction to a blockchain includes writing the transactions to a blockchain of the federation of the validator nodes, and the federation's blockchain is specific to that blockchain (e.g., it is different from any blockchains of its parent and children federations). In some embodiments, writing the transaction to a blockchain includes writing at least one of the outgoing IFBs to the blockchain. In some embodiments, writing the transaction to a blockchain includes writing at least one of the incoming IFBs to the blockchain.

In some embodiments, outgoing IFB destinations are determined by examining a recipient address of a transaction in an incoming IFB.

In some embodiments, repackaging incoming IFBs to outgoing IFBs may include determining whether the incoming IFBs should be merged before spliced. For example, if the incoming IFBs are sorted by destination, then a merge may precede a splice. By contrast, if the incoming IFBs are not sorted by destination, then a splice may precede a merge.

In FIG. 8D, the top level federation validator nodes process the IFBs from the middle level federations. The top level validator nodes include processors configured to receive incoming IFBs from middle level federations, create outgoing IFBs from the incoming IFBs, route the outgoing IFBs to the middle level federations, and write transactions associated with the outgoing IFBs to a blockchain of the top level federation. The top level validator nodes may process the incoming IFBs and create outgoing IFBs in the same way as the middle level validator nodes.

Also in FIG. 8D, the bottom level federations process the user transactions in FIG. 8C. These additional transactions may be processed in the same way as the transactions of FIG. 8B. One difference from FIG. 8A is that transaction 850 is an intra-federation transaction. As such, the validator nodes in Federation 810 do not include transaction 850 in an IFB to Federation 804; it is simply written (once validated) to the blockchain of Federation 810.

In FIG. 8E, the transactions continue through the system. The validator nodes in Middle Level Federation 804 are now processing incoming IFBs from the parent federation (the top level federation) and the child federations (in some embodiments, a child federation may not validate its parent federation's IFBs). Once the incoming IFBs are processed, outgoing IFBs are created and routed to their respective destinations.

In FIG. 8F, FIG. 8A transactions that originated in Federation 810 have arrived in Federation 816 and FIG. 8A transactions that originated in Federations 814 and 816 have arrived in Federations 810 and 812. Meanwhile, the FIG. 8C transactions have arrived at the top level federation. In FIGS. 8G and 8H, the FIG. 8C transactions continue through the Network 800 to arrive at their respective destination federations.

In some embodiments, one or more federations may be a private entity (a bank, for example) with its own rules independent of the remainder of the validation network. For example, a private federation may reduce or increase limits on maximum fund transfer, change requirements for second authorizations, etc. To the remainder of the validation network, the private federation operates in the same way as the other public federations. In some embodiments, the private federation can stop or reroute incoming and/or outgoing inter federation transactions for any reason (e.g. fraud detection, anti money laundering, etc). In some embodiments, the private federation provides privacy by not exposing, to the rest of the network, information about accounts (or other personal information) inside the federation.

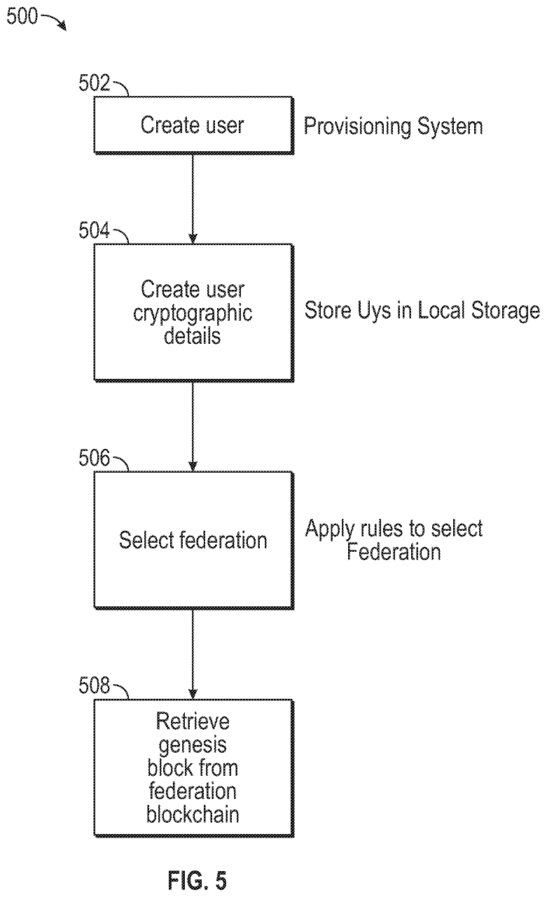

FIG. 5 is a flow chart of a method of assigning a user to a federation in accordance with an embodiment. New user creation process is comprised of multiple steps, sometimes visible to the user but other times hidden. The user is created in the system 502 and user data is provisioned in the database. The user is provided with its cryptographic keys 504 to be used during transaction exchange and to authenticate the validity of its transactions and signatures. Based on multiple business rules, a federation is assigned to the User 506. The computer software running on the user's device retrieves current and historical information from its federation blockchain 508 to be used during the normal interaction with the federation.

Some embodiments implement the system without the need for the routing nodes and without the transactions being routed between Federations Level 0. In these embodiments, all transactions can be transmitted through the Validation Network.

Some embodiments implement the system without the Audit Nodes. The auditing nodes may be used as a second, redundant layer of security, and as such are optional.

Some embodiments implement the system without the Validation Network, and instead have the routing nodes, the membership federation and the auditing nodes. In such embodiments, all transactions can be extremely fast and the auditing nodes would be in charge of ensuring the integrity of the transactions across the entire system.

In addition, in all of the embodiments mentioned above in which the Validation Network is implemented, the pyramidal topology of the network shown in FIG. 1 is not required. Some embodiments implement the system based on alternative topologies such as a Bidirectional Directed Acyclic Graph or other suitable topologies.

In addition, in all embodiments where the Validation Network is present, one could implement the system by not requiring the Validation Network to store a blockchain of transactions. In such embodiments the Validation Network would validate and route transactions appropriately but it wouldn't necessarily have a ledger of such transactions in a persistent storage.

In addition, in all embodiments where the Validation Network is present, one could implement the system eliminating the witness nodes. The witness nodes can serve at least one of performance and security, but neither is 100% required for all implementations. Improved performance is achieved by witness nodes “pre-validating” the transactions sent to its validation federation. Additional security is achieved by witness nodes having continuous visibility of all the transactional activity being performed in the federation for which the node is a witness. These features, while beneficial, are optional.

In addition, in all the cases mentioned above in which the auditing nodes are present, one could implement the system with federated auditing nodes and, in such case, they would be implemented as audit federations instead of just auditing nodes.

In addition, in all the cases mentioned above, one could implement the system replacing the membership federation by another type of node membership system that is not federated.

In addition, one could implement the system to allow for the membership of nodes to federations to change overtime or to be permanent. In some implementations, the validation nodes' membership changes over time based on specific rules, while the user nodes memberships are permanent and always associated to a single Federation Level 0. These rules, while desirable, are optional.

In addition, one could implement the system to allow for the payload of the transactions to be modules of data and computer readable instructions that are executed by the network and are interpreted and/or parsed by the network.

In some embodiments, a blockchain system includes distributed applications (“DAPPs”). The DAPPs may be run by nodes on top of the blockchain system. For example, a blockchain system can replace an escrow system using DAPPs. Each party sends the contract assets and, once all assets have been received, the system simultaneously swaps the ownership of each asset to the other party. If one of the parties doesn't submit the asset within a specified time window, the assets are returned to the owner.

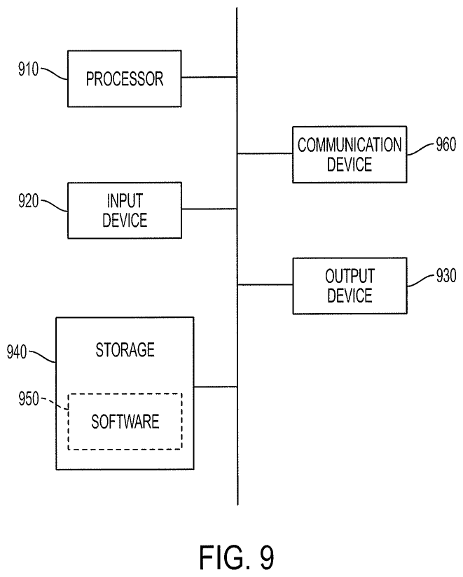

FIG. 9 illustrates an example of a computing device in accordance with one embodiment. Device 900 can be a host computer connected to a network. Device 900 can be a client computer or a server. As shown in FIG. 9, device 900 can be any suitable type of microprocessor-based device, such as a personal computer, workstation, server or handheld computing device (portable electronic device) such as a phone or tablet. The device can include, for example, one or more of processor 910, input device 920, output device 930, storage 940, and communication device 960. Input device 920 and output device 930 can generally correspond to those described above, and can either be connectable or integrated with the computer.

Input device 920 can be any suitable device that provides input, such as a touch screen, keyboard or keypad, mouse, or voice-recognition device. Output device 930 can be any suitable device that provides output, such as a touch screen, haptics device, or speaker.

Storage 940 can be any suitable device that provides storage, such as an electrical, magnetic or optical memory including a RAM, cache, hard drive, or removable storage disk. Communication device 960 can include any suitable device capable of transmitting and receiving signals over a network, such as a network interface chip or device. The components of the computer can be connected in any suitable manner, such as via a physical bus or wirelessly.

Software 950, which can be stored in storage 940 and executed by processor 910, can include, for example, the programming that embodies the functionality of the present disclosure (e.g., as embodied in the devices as described above).

Software 950 can also be stored and/or transported within any non-transitory computer-readable storage medium for use by or in connection with an instruction execution system, apparatus, or device, such as those described above, that can fetch instructions associated with the software from the instruction execution system, apparatus, or device and execute the instructions. In the context of this disclosure, a computer-readable storage medium can be any medium, such as storage 940, that can contain or store programming for use by or in connection with an instruction execution system, apparatus, or device.

Software 950 can also be propagated within any transport medium for use by or in connection with an instruction execution system, apparatus, or device, such as those described above, that can fetch instructions associated with the software from the instruction execution system, apparatus, or device and execute the instructions. In the context of this disclosure, a transport medium can be any medium that can communicate, propagate or transport programming for use by or in connection with an instruction execution system, apparatus, or device. The transport readable medium can include, but is not limited to, an electronic, magnetic, optical, electromagnetic or infrared wired or wireless propagation medium.

Device 900 may be connected to a network, which can be any suitable type of interconnected communication system. The network can implement any suitable communications protocol and can be secured by any suitable security protocol. The network can comprise network links of any suitable arrangement that can implement the transmission and reception of network signals, such as wireless network connections, T1 or T3 lines, cable networks, DSL, or telephone lines.

Device 900 can implement any operating system suitable for operating on the network. Software 950 can be written in any suitable programming language, such as C, C++, Java or Python. In various embodiments, application software embodying the functionality of the present disclosure can be deployed in different configurations, such as in a client/server arrangement or through a Web browser as a Web-based application or Web service, for example.

The foregoing description, for purpose of explanation, has been described with reference to specific embodiments. However, the illustrative discussions above are not intended to be exhaustive or to limit the disclosure to the precise forms disclosed. Many modifications and variations are possible in view of the above teachings. The embodiments were chosen and described in order to best explain the principles of the techniques and their practical applications. Others skilled in the art are thereby enabled to best utilize the techniques and various embodiments with various modifications as are suited to the particular use contemplated.

Although the disclosure and examples have been fully described with reference to the accompanying figures, it is to be noted that various changes and modifications will become apparent to those skilled in the art. Such changes and modifications are to be understood as being included within the scope of the disclosure and examples as defined by the claims.

This application discloses several numerical ranges in the text and figures. The numerical ranges disclosed inherently support any range or value within the disclosed numerical ranges, including the endpoints, even though a precise range limitation is not stated verbatim in the specification because this disclosure can be practiced throughout the disclosed numerical ranges.

The above description is presented to enable a person skilled in the art to make and use the disclosure, and is provided in the context of a particular application and its requirements. Various modifications to the preferred embodiments will be readily apparent to those skilled in the art, and the generic principles defined herein may be applied to other embodiments and applications without departing from the spirit and scope of the disclosure. Thus, this disclosure is not intended to be limited to the embodiments shown, but is to be accorded the widest scope consistent with the principles and features disclosed herein. Finally, the entire disclosure of the patents and publications referred in this application are hereby incorporated herein by reference.

What is claimed is:

1. A blockchain method performed by a validator node of a first federation, the validator node comprising a transceiver and a processor, the method comprising:
receiving, via the transceiver, incoming interfederation blocks (“IFBs”) from a second federation different than the first federation;
validating, at the processor, the incoming IFBs to create validated IFBs;
splicing, at the processor, the validated IFBs into validated transactions between payer-federation and receiver-federation pairs;
merging, at the processor, the validated transactions based on the respective destinations of each validated transaction to create outgoing IFBs;
transmitting, via the transceiver, a proposal to other validator nodes in the first federation that an IFB of the outgoing IFBs be routed to a third federation different than the first federation and the second federation; and
transmitting, via the transceiver, a proposal to other validator nodes in the first federation that that a transaction associated with the IFB of the outgoing IFBs be written to a blockchain.

2. The method of claim 1, wherein the second federation is a parent federation of the first federation and wherein the third federation is a child federation of the first federation.

3. The method of claim 1, wherein the second federation is a child federation of the first federation and wherein the third federation is a parent federation of the first federation.

4. The method of claim 1, wherein the second federation is a child federation of the first federation and wherein the third federation is a child federation of the first federation.

5. The method of claim 1, wherein the incoming IFBs and outgoing IFBs comprise aggregated amounts of transactions between multiple federations.

6. The method of claim 1, wherein writing the transaction to a blockchain comprises writing the transactions to a blockchain of the first federation, wherein the first federation's blockchain is different from a blockchain of the second federation and a blockchain of the third federation.

7. The method of claim 1, wherein writing the transaction to a blockchain comprises writing the payer-federations, the receiver-federations, and an aggregated transaction amount to the blockchain.

8. The method of claim 1, wherein writing the transaction to a blockchain comprises writing at least one of the outgoing IFBs to the blockchain.

9. The method of claim 1, further comprising broadcasting the outgoing IFBs to the receiver federations.

10. The method of claim 1, further comprising determining the receiver federation by examining a recipient address in the IFB.

11. The method of claim 1, further comprising:
transmitting, via the transceiver, a proposal to other validator nodes in the first federation that a second IFB of the outgoing IFBs be routed to a fourth federation different than the first federation, different from the second federation, and different form the third federation; and
transmitting, via the transceiver, a proposal to other validator nodes in the first federation that a transaction associated with the second IFB of the outgoing IFBs be written to the blockchain.

12. A blockchain method performed by a validator node of a first federation, the validator node comprising a transceiver and a processor, the method comprising:
receiving, via the transceiver, a transaction from a user node of the first federation;
validating the transaction to create a validated transaction;
determining if the validated transaction is an inter-federation transaction or an intra-federation transaction;
in response to a determination that the validated transaction is an inter-federation transaction:
merging, into an outgoing IFB, the validated transaction with other inter-federation transactions,
transmitting, via the transceiver, a proposal to other validator nodes in the first federation that the outgoing IFB be routed to a second federation different than the first federation, and
transmitting, via the transceiver, a proposal to other validator nodes in the first federation that the transaction be written to a blockchain; and
in response to a determination that the validated transaction is an intra-federation transaction:
transmitting, via the transceiver, a proposal to other validator nodes in the first federation that the validated transaction be written to a blockchain.

13. A multi-federation blockchain system comprising validator nodes, the multi-federation blockchain system comprising:
a top level federation comprising validator nodes, each validator node comprising a processor configured to:
receive incoming IFBs from middle level federations;
create outgoing IFBs from the incoming IFBs;
route the outgoing IFBs to the middle level federations; and
write transactions associated with the outgoing IFBs to a blockchain of the top level federation;
the middle level federations comprising validator nodes, each validator node comprising a processor configured to:
receive incoming IFBs from the top level federation and bottom level federations;
create outgoing IFBs from the incoming IFBs;
route the outgoing IFBs to the top level federation and the bottom level federations; and
write transactions associated with the outgoing IFBs to a blockchain of the middle level federation different from the blockchain of the top level federation; and
the bottom level federations comprising validator nodes, each validator node comprising a processor configured to:
receive incoming IFBs from the middle level federations;
receive transactions from user nodes of the respective bottom level federations;
create outgoing IFBs from the transactions of the user nodes;
route the outgoing IFBs to middle level federations; and
write the transactions from the user nodes and transactions from the incoming IFBs to a blockchain of the bottom level federation different from the blockchain of the top level federation and different from the blockchain of the middle level federation.

14. The multi-federation blockchain system of claim 13, further comprising a membership federation having validator nodes, each validator node comprising a processor configured to assign validator nodes to one of the top level federation, middle level federations, and bottom level federations.

15. The multi-federation blockchain system of claim 13, further comprising routing nodes, each routing node comprising a processor configured to broadcast transactions between bottom level federations.

16. The multi-federation blockchain system of claim 13, further comprising auditing nodes, each auditing node comprising a processor configured to monitor actions by the validator nodes for compliance with rules of the respective federations.

17. The multi-federation blockchain system of claim 13, wherein the top level federation mints currency for the multi-federation blockchain system.

18. The multi-federation blockchain system of claim 13, wherein the processor of each validator node is configured to create an outgoing IFB by:
validating the incoming IFBs to create validated IFBs;
splicing the validated IFBs into validated transactions between payer-federation and receiver-federation pairs; and
merging the validated transactions based on the respective destinations of each validated transaction to create the outgoing IFB.

19. The multi-federation blockchain system of claim 18, further comprising a witness node of a first federation, the witness node comprising a processor configured to:
validate the incoming IFBs of a second federation.
